(19) United States
(12) Patent Application Publication
(10) Pub. No.: US 2008/0254294 A1
(43) Pub. Date: Oct. 16, 2008

(54) Multi-functional coating material, method of making and products made therefrom

(75) Inventor: Larry K. Findley, Fremont, OH (US)

Correspondence Address: MARSHALL & MELHORN, LLC, FOUR SEAGATE - EIGHTH FLOOR, TOLEDO, OH, 43604, US

(73) Assignee: Neumont Ventures, LLC

(21) Appl. No.: 12/012,664

(22) Filed: Feb. 5, 2008

Related U.S. Application Data
(60) Provisional application No. 60/923,239, filed on Apr. 13, 2007.

(51) Int. Cl. B32B 27/00; C08G 65/00; B05D 3/02; C04B 14/00

(52) U.S. Cl. 428/407; 524/612; 427/372.2; 106/400

(57) ABSTRACT

The present invention relates to a liquid multi-functional coating material having a multi-pigment/additive portion, and a liquid organic solvent portion and methods of making and utilizing the same.

### RELATED APPLICATION

This application is claiming the benefit, under 35 U.S.C. 119(e), of the provisional application filed Apr. 13, 2007 under 35 U.S.C. 111(b), which was granted Ser. No. 60/923,239. This provisional application is hereby incorporated by reference in its entirety.

### BACKGROUND OF THE INVENTION

Over at least the past several decades, offering all different sorts of goods with an ever-increasing choice of options has become an important sales/marketing tool. One such option offered is often a wide array of colors of such goods. In particular, goods made of polymeric material have become prevalent. Much research has been conducted to develop materials and methods for imparting color, or other coating properties to provide a certain desired appearance, to such polymeric materials. Often, such materials and methods have been found to have limited applicability to certain types of polymeric materials due to the characteristics of the polymeric material itself, due to the conditions under which the polymeric material must be processed, e.g., high temperature, due to the limitations of the colorant material itself, e.g., low color intensity, low color saturation, poor color durability, etc., or some combination of these and, perhaps, other factors.

It is known that, for a variety of reasons, coloring/coating materials in liquid form have the potential to solve some of the problems of limited applicability as have herein been described. However, such liquid coloring/coating materials and methods of incorporation have, thus far, had limited success in meeting the demanding requirements for coloring/coating polymeric materials. Thus, it would be advantageous to have a liquid coloring/coating material which is relatively simple, but has the flexibility to provide a broad array of colorants/coatings which are compatible with many different types of polymeric materials, while meeting the customer's specification/requirements for such colorants/coatings.

Liquid coloring/coating materials and methods of making same appear in the patent literature. For example:

U.S. Pat. No. 6,031,024 describes an inkjet recording liquid obtained by dispersing colorant particles in a water-based liquid, the colorant particles being a product formed by coating resin particles having an average particle diameter of 50 to 300 nm with an organic pigment.

U.S. Pat. No. 6,666,914 describes a black colorant for ink-jet printing ink, in which black pigments are adhered onto the surface of an extender pigment through a gluing agent in the form of a uniform adhesion coat, while being kept in an extremely finely dispersed state, and which is said to exhibit not only a high tinting strength and high blackness, but also excellent dispersibility and light resistance.

U.S. Pat. No. 6,800,127 describes pigment preparations comprising polyamide particles with an average particle size below 50 μm and a pigment with an average particle size below 0.2 μm. The pigment preparations are said to be useful for coloring high molecular weight material, for example, coatings, inks, and particularly plastics such as polyvinyl chloride, polyamide, polyester, polycarbonate, and especially, polyamide fibers.

U.S. Pat. No. 6,884,289 describes colored pigments based on multi-coated platelet-shaped substrates having a certain arrangement of optically functional layers and an outer layer consisting of absorption pigments which are said to produce particular color effects.

U.S. Pat. No. 6,792,305 describes a non-dusting homogeneous pigment preparation comprising at least 40% by weight of one or more effect pigments, 0.5-50% by weight of water and/or an organic solvent or solvent mixture, and 0.5-59.5% by weight of a styrene-modified polyacrylate resin having an acid number of >90 mg. KOH/g based on the pigment. Pigment preparations of the kind described are said to be particularly suitable for producing dry preparations, for example, granules, which in turn are said to be suitable for pigmenting printing inks.

U.S. Pat. No. 7,135,504 describes an ink composition for ultraviolet curable ink-jet recording which contains a stable dispersion of carbon black and is said to provide excellent dispersion and discharge stability. A process for producing such an ink composition is also described.

U.S. Published Patent Application No. 2005-0123759 describes a resin for use in molding, sintering or extruding finished parts, the resin comprising a plurality of polymeric particles and a coating of at least one additive covering each of the polymeric particles. The method of preparing the resin comprises the steps of combining at least one additive, a plurality of polymeric particles, and at least one liquid to form a suspension; and removing at least a portion of the liquid from the suspension to thereby form at least a partial additive coating on each polymeric particle.

### SUMMARY OF THE INVENTION

The present invention relates to a liquid multi-functional coating material having a multi-pigment/additive portion and a liquid organic solvent portion. When mixed, the pigment/additive portion comprises the minority of the total percent by weight of the mixture, and the liquid organic solvent portion comprises the majority of the total percent by weight of the mixture. In particular, such pigments are color or “effect” pigments. A wide variety of additives and liquid organic solvents are suitable for use in connection with the present invention. Another aspect of the invention relates to a method of making the multi-functional coating material.

Among the uses of the liquid multi-functional coating material is as applied to a polymeric granule to encapsulate such granule in a manner so as to form a “ready-to-process” coated particle for use, by for example, a manufacturer of plastic products.

The versatility of the multi-functional coating material of the present invention also allows it to be suitable for use as a coating material for items made from various polymeric materials.

### BRIEF DESCRIPTION OF THE DRAWINGS

FIG. 1 shows a cross-sectional view of a “ready-to-process” coated particle in accordance with the invention.

FIG. 2 shows a schematic diagram of the process of making a “ready-to-process” granule according to an aspect of the invention.

### DETAILED DESCRIPTION OF THE INVENTION

The present invention relates to a liquid multi-functional coating material, a method of making such liquid multi-functional coating material, methods of utilizing the liquid multi-functional coating material.

Many methods of coloring or creating other types of effects in polymeric materials are known, including, for example, colorants in both solid and liquid forms. Likewise, many methods of coloring or creating other effects in, for example, paints, are known.

Heretofore, there has not been a single material system which can perform all of the above-described functions relatively simply, and cost effectively. The present invention has been shown to be capable of meeting high standards of performance when used in forming “ready-to-process” coated particles which can, in turn, be used in, for example, manufacture of molded plastic articles, and also as coating materials for various polymeric articles.

It has been found that the color concentrate material of commonly-owned U.S. Pat. No. 5,176,751 works especially well as one of the components of the multi-functional liquid coating material of the present invention, and is incorporated herein by reference, in its entirety.

The multi-pigment/additive component of the present invention which preferably utilizes the color concentrate material of the '751 patent can be illustrated generally, as:

One or more organic pigments comprising 1-20% by weight of the multi-pigment/additive portion.

One or more inorganic pigments comprising 40-79% by weight of the multi-pigment/additive portion.

Optionally, one or more functional additives such as coupling agents, binding agents, UV stabilizers, and the like.

More specifically, Examples 1-5 illustrate a few possible variants of the multi-pigment/additive component of the present invention.

### EXAMPLE I

| Ingredient | Percent by Weight |
|---|---|
| Titanium dioxide | 33.72% |
| Carbon Black | 7.27% |
| Zincferrite Yellow | 8.00% |
| CI Pigment Red 202 | 0.73% |
| Sorbitan monastearate | 2.00% |
| Cisopropyl tri-titanate | 0.20% |
| Maleic anhydride | 14.43% |
| UV Screener | 12.22% |
| UV Absorber | 12.22% |
| A/C6 LMWPE Wax | 9.21% |
| Total Formulation | 100.00 |

### EXAMPLE 2

| Ingredient | Percent by Weight |
|---|---|
| C.I. White #6 (TiO₂) | 79.00% |
| C.I. Carbon Black #7 | 0.25% |
| C.I. Pigment Blue #60 | 0.25% |
| C.I. Pigment Red #178 | 0.25% |
| C.I. Pigment Yellow #139 | 0.25% |
| Zinc Stearate Lubricant | 2.00% |
| HALS Light Stabilizer | 18.00% |
| Total Formulation | 100.00 |

### EXAMPLE 3

| Ingredient | Percent by Weight |
|---|---|
| C.I. Pigment Violet #19 | 24.00% |
| C.I. Pigment Red #104 | 55.95% |
| 7051 Silicone Modifier | 2.00% |
| Wild Strawberry Fragrance | 5.00% |
| B-225 Antioxidant | 1.00% |
| NZ12-H Crosslinker | 0.35% |
| A/C 6 LMWPE Wax | 11.70% |
| Total Formulation | 100.00 |

### EXAMPLE 4

| Ingredient | Percent by Weight |
|---|---|
| Bismuth Vanadate Yellow | 56.00% |
| C.I. Pigment Yellow #93 | 20.00% |
| C.I. White #6 | 4.00% |
| Saytex BT-93 Flame Ret. | 7.00% |
| NZ12-H Crosslinker | 1.00% |
| HALS Light Stab./Binder | 12.00% |
| Total Formulation | 100.00 |

### EXAMPLE 5

| Ingredient | Percent by Weight |
|---|---|
| Pigment Blue #15:1 | 15.00% |
| Pigment Blue #29 | 60.00% |
| Hydrocerol BH Blowing Agent | 3.00% |
| Sodium Stearate Process Aid | 2.0% |
| Magnesium Hydroxide Filler | 5.00% |
| LMWEVA Binder | 15.00% |
| Total Formulation | 100.00% |

Preferably, the multi-pigment/additive portion of the present invention will have at least 45% by weight inorganic pigment. In addition, on the order of five percent by weight organic pigment is useful in many cases; preferably, at least one percent by weight organic pigment is added where vivid color is desired. Preferably, the multi-pigment/additive portion will contain 50% to 90% pigment by weight (including both organic and inorganic). More preferably, the multi-pigment/additive portion will contain 70% to 90% pigment by weight and, more preferably still, the multi-pigment/additive portion will contain 80% to 90% pigment by weight.

The multi-pigment/additive portion is, typically, comprised of pigment and carrier. As used in the specification and claims, “pigment” can include mixtures of different pigments. The multi-pigment/additive portion of the present invention, typically, is about 30% to about 90% pigment and functional additives by weight and the balance is carrier. Organic pigments typically utilized include quinacridones and phthalocyanines and also azo-type pigments. Typical inorganic pigments include nickel titanate, titanium dioxide, carbon black, cobalt, and manganese chrome antimony titanate. Organic pigments are generally more expensive than inorganic pigments. Typical organic and inorganic pigments are listed in Modern Plastics Encyclopedia, Mid-October 1989 Issue, Vol. 66, No. 11, Mc-Graw-Hill, Inc., 1989, at pages 648-660, and the Kirk-Othmer Concise Encyclopedia of Chemical Technology, John Wiley & Sons, Inc. 1985, at pages 303-304 and 887-892, and The Plastic Additives Handbook, 5^{th} Ed., Hanser Gardner Publications, Inc., 2001, at pages 822-881, the contents of each of which is hereby incorporated by reference.

The present invention disperses organic pigments very well. Due to the oil absorption rate of organic pigments, one cannot achieve as high a loading level with organic pigments as one can with the inorganic pigments in color concentrate granules of the present invention. One can achieve up to about 40% to 42% loading levels of organic pigments and up to about 90% loading levels of inorganic pigments in the granules of the present invention. (Percentages are on a by-weight basis unless otherwise indicated.)

In the present invention, it is typically preferable to use combinations of organic and inorganic pigments. Typically, in such a case the organic pigment is used as a toner to give vivid color, while the inorganic pigment, which tends to be non-transparent provides a more opaque color and “fills up” the color so as to reduce transparency. Typically, high levels of inorganic pigments are used in combination with lower levels of organic pigments.

A carrier is utilized to bind the pigment and also generally operates to wet the pigment so that it is more dispersible in the natural resin to be colored. Bis stearamide wax is a preferred carrier, although any material which is meltable, exhibits viscous flow, and posses lubricating compatibility, may be a suitable carrier.

A carrier is not necessarily a single compound; combinations of ingredients can be utilized as a carrier, which may also be referred to as a “carrier system.”

To make the multi-pigment/additive portion of the present invention, it is preferable to utilize a high intensity, bowl-type mixer, such as is known in the art and is available, for example, from the Henschel Company in Germany. It has a large rotary impeller that mixes and agitates the ingredients. The pigment and carrier, both in powdered form, are placed in the bowl without preheating. The mixer agitates and whips the ingredients by means of the impeller. This action frictionally raises the temperature of the ingredients. Heat is, thus, substantially mechanical rather than electrical or gas combustion in origin. As the melting point is approached, the carrier softens and agglomerates with the pigment particles. The pigment becomes wetted, ground, solvated, and encapsulated by the carrier. Encapsulation prevents the pigment from reagglomerating, and thus results in excellent pigment dispersion.

The high-intensity mixer is run until the power consumption drops to a level which indicates that the encapsulation process is complete. Granules, which are rounded, sphere-like particles, of the mixed pigments/additives and carrier are formed by this process. The granules are preferably about 10 microns to about 50 microns in diameter, and more preferably about 10 microns to about 30 microns in diameter. These granules can include up to about 90% pigment by weight. Processing the powdered pigment and carrier through the high intensity mixer can increase the bulk density of the mixture from about 1.75 times to about 3.5 times.

The granular multi-pigment/additive/carrier material just described herein then becomes a feedstock component of the process to form the liquid multi-functional coating material of the present invention. Preferably, the granular material comprises 20-30% by weight of the liquid multi-functional coating material and the remainder comprises an organic solvent. Examples of suitable organic solvents include: water and hydrocarbons, long-chain amines, vegetable oils, monohydric aliphatic alcohols such as: ethanol, butanol, isopropanol; ketones, e.g., acetone or methylethyl ketone; glycol ethers such as propylene glycolmonomethyl ether, diols such as ethylene glycol and propylene glycol; polyether diols, aliphatic triols and tetrols having 2-6 carbon atoms such as trimethylolethane, 1,2,6-hexane triol, pentaerythritol, glycerol, 1,2,4-butanetriol, tetrahydrofuran and N-methyl-2 pyrrolidone and mixtures of the above-noted solvents.

Such solvents typically comprise the liquid feedstock component of the liquid multi-functional coating material, preferably comprising 70-80% by weight of the total weight of the liquid coating material.

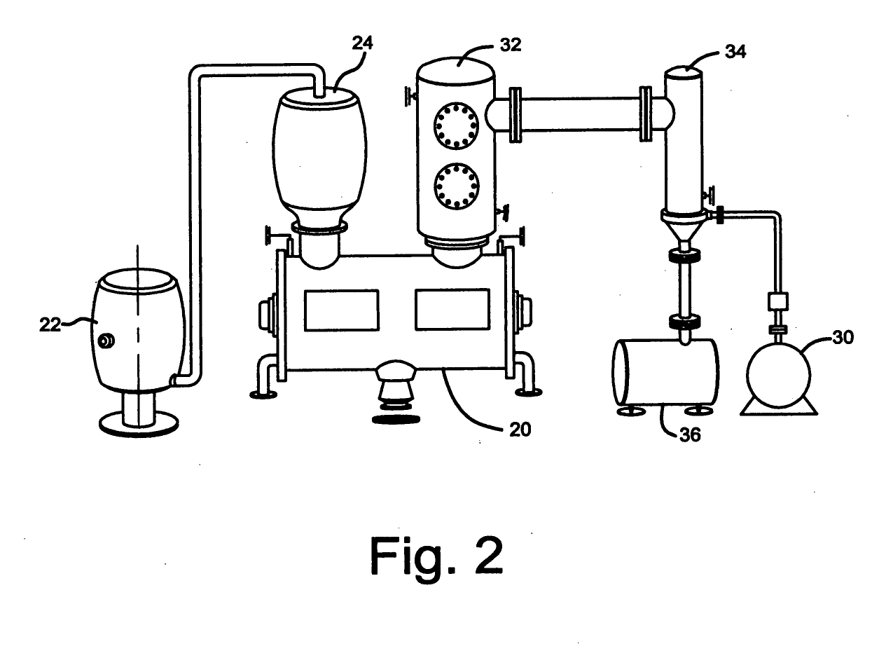

While a variety of methods of combining the granular and liquid feedstock components may be suitable, a preferred method includes at least the following steps and, which is also shown diagramatically in FIG. 2.

A desired quantity of the granular multi-pigment/additive/carrier material is weighed and utilized to charge disperser vessel 22. A pre-measured quantity of liquid organic solvent is also pumped into disperser vessel 22, whereupon, disperser vessel 22 is energized causing an impeller inside disperser vessel 22 to rotate at high speed (e.g., 3600 rpm) for a time period sufficient to thoroughly mix the granular material and the liquid organic solvent, preferably 2 to 5 minutes. The liquid coating material now formed is then, typically, sampled and tested for compliance with specifications for various parameters such as viscosity, dispersion and color. If satisfactory, the liquid coating material may then be transferred to an agitated holding tank for storage, or for further utilization in other processes.

The process of creating a liquid coating material as just described allows ready combination of an array of pigments, combination of pigments and dyes, and combinations of pigments and functional additives such as coupling agents, binding agents, UV stabilizers and the like. Additionally, the process allows for the incorporation of a wide variety of “effect” materials, for example, materials to create metallic, phosphorescent, pearlescent and like visual effects, as well as other types of effects, such as fragrances.

One such process in which the liquid, multi-functional coating material is particularly useful, is in the creation of a “ready-to-process” coated particle, for example, a coated thermoplastic polymer particle, more particularly, a coated engineering polymer particle.

It is generally known that “pre-coloring” and addition of functional additives are, in conventional compounding processes, almost always secondary compounding steps. In such secondary compounding steps, a, for example, thermoplastic polymer particle, may be undesirably subjected to an invasive “melt history” which compromises certain physical properties (e.g., UV resistance, elasticity, tensile strength and heat deflection temperature) of such thermoplastic polymer particle. One objective of the process of the present invention is to avoid subjecting a thermoplastic polymer granule to be coated to such undesirable heating.

It is also known, that in traditional compounding processes it is necessary to pre-dry the thermoplastic polymer particles prior to performing secondary compounding steps as just described herein, due to the hydrophilic nature of many thermoplastic polymer materials. Examples of polymer materials which are suitable for coating within the scope of the present invention include: ABS, PET, polypropylene, high-density polyethylene, low-density polyethylene, nylon, polycarbonate, polyvinyl chloride, polyesters, acetyls and polystyrene. The process of the present invention is intended to eliminate the need for such pre-drying operations, thus, streamlining the overall compounding process, and creating a “ready-to-process” coated polymeric granule.

The process of forming a “ready-to-process” coated polymeric particle in accordance with the invention will now be described in more detail.

As shown in FIG. 2, a coating vessel 20 is provided, typically a cylindrical stainless steel vessel of substantial physical integrity, as it may be heated, subjected to significant internal negative pressure (vacuum) and to mechanical rotation. In a preferred configuration, the cylindrical stainless steel vessel is steam-jacketed, is vacuum pressurized and is equipped with a plurality of injectors for injection of the liquid multi-functional coating material. The vessel contains an assembly which is capable of selectively rotating the material inside the coating vessel 20, for example, during addition of the liquid coating material to the coating vessel 20.

As an initial process step, a granular component comprising, primarily, the thermoplastic polymer material to be coated, is placed in the coating vessel 20 in a predetermined amount, for example, 80-90 weight percent, possibly as high as 99 weight percent, of the total weight of the “batch” of coated thermoplastic polymeric particles. An example of a thermoplastic polymeric material which can be coated by the process of the present invention is Santoprene® as sold by Advanced Elastomer Systems, Inc., a division of Exxon-Mobil Corporation.

Other desired additives may also be added at this time, for example, one or more “coupling agents”, as are known to those skilled in the art. Various titanate compounds may serve as such coupling agents and typically represent from 0-1% by weight of the total batch.

The coating vessel 20 is then sealed so as to be liquid and air tight and is pressurized, as necessary, by pressurized surge tank 24. The drum-like assembly inside the coating vessel 20 is, preferably, rotated at a speed so as to facilitate uniform exposure of the thermoplastic polymer material to the liquid coating material. Through the previously mentioned injectors, the liquid coating material is discharged into the coating vessel in a predetermined amount and in a manner so as to maximize the uniformity of coating of the thermoplastic polymeric particles. The liquid coating material is circulated among the plurality of thermoplastic polymer granules for a time to achieve coating uniformity, which can be checked by removal of test specimens from the coating vessel. Typically, such time is in the range of 15-30 minutes.

Upon achieving a desired level of color uniformity, the coating vessel 20 is heated up to a temperature lower than the melt temperature of either of the coating material or the thermoplastic granules which have been coated. Simultaneously, negative pressure sufficient to create a useful partial vapor pressure is applied via vacuum pump 30 to the interior portion of the coating vessel 20 in order to draw out the free liquid/vapor portion of the liquid coating material through a collection device 32. The partial vapor pressure necessary will vary with the solvent utilized. Condenser 34 and solvent recovery tank 36 are utilized to provide recovery of a substantial percentage of the solvent initially utilized in the process.

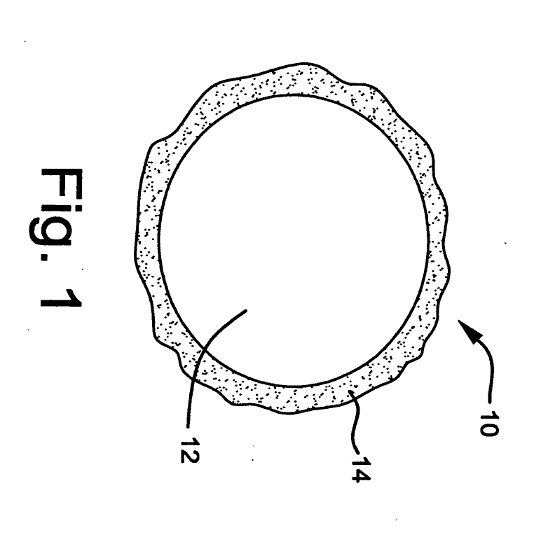

The material remaining after completion of the aforementioned process is a dry, thermoplastic granule 10 with a uniform coating 14, i.e., a “ready-to-process” coated particle as shown in FIG. 1. It is a noteworthy feature of the present invention, that the initial moisture content of the thermoplastic polymer granule 10 prior to coating is no more than 0.25 weight percent and the moisture content of the coated thermoplastic polymer particle 12 is no more than 0.25 weight percent greater than the initial moisture content of the thermoplastic granule 10. This is a significant benefit to downstream users, such as extruders, blowmolders and injection molders, of the coated thermoplastic polymer granules 12 as most often, for their purposes; the material is then “ready-to-process”. It is a further advantage of the “ready-to-process” coated particle that the coating will help to minimize the amount of moisture absorbed by the material during transit to downstream users.

In the process of making the “ready-to-process” thermoplastic polymer particles 12, it is possible that some of the multi-pigment/additive portion may become dislodged from the base thermoplastic granule 10 bearing the coating 14, forming “fines” or “dust” which may be undesirable for downstream processing of the “ready-to-process” thermoplastic polymer coated particle 12. Optionally, it may be desirable to screen the “ready-to-process” coated particles 12 to remove such “fines.”

As noted herein, one aspect of the coating applied to the thermoplastic polymer granules is to serve as a source of color in downstream processes. Various characteristics of color are desirable for such downstream manufacturers, including, by way of example, color uniformity, color saturation, and color intensity. As used herein, these terms have the following meanings:

Color uniformity—the uniformity of the hue within a batch of material, and/or from batch to batch; various known ways of expressing/measuring, e.g., color coordinate systems, cpk system.

Color saturation—refers to the intensity of a specific hue; also known as color purity.

Color intensity—refers to the brightness or dullness of a hue. May be lowered by adding white or black.

Another parameter of interest is the spray viscosity of the liquid coating material, and is expressed by the number of seconds in a #4 Ford cup per ASTM standard. Preferably, the viscosity of the liquid coating material is at least 28 seconds in a #4 Ford cup.

A further parameter of interest is the durability of the coating material. The durability of a multifunctional coated polymer bead can be expressed as its ability to resist weathering, fading, aging, visible ambient light resistance, ultra-violet radiation resistance, infrared radiation resistance, humidity, and resistance to extended exposure to temperature. There are various methods available to make these determinations with one of the most widely used being the Q-Panel QUV Test Chamber or the Q-Panel Xenon Weatherometer with both units being supplied by The Q-Panel Company, Inc.

Weathering standard DIN 53231 states artificial weathering parameters for these tests. After exposure, the durability is measured by a recording spectrophotometer (exposed specimens (test) vs. non-exposed specimens (control)). The measurement results when the spectrophotometer is setup to color difference in L, a, b color space. It is desirable that the color difference be maintained between from 0.25 ΔE to 1.5 ΔE. The ΔE is calculated from the L, a, b data.

The liquid multi-functional coating material of the present invention made by the previously described process can also be utilized for other coating purposes.

The ability of the herein described coating material to combine pigments, dyes and functional additives provides great versatility in being suitable as a coating material which may be applied directly to items made from sheets or panels of polymeric materials. Just a few examples of such applications are: plastic cases for electronic devices, automotive parts, both interior and exterior, and many others.

It is an advantage of the liquid multi-functional coating material of the present invention that desired coating properties can be achieved with smaller amounts of the liquid material than with comparable dry materials, which provides cost savings, as well. Not wishing to be bound to any theory, it is believed that lesser amounts of the coating material of the present invention can be used due to the high pigment loading achievable with the material and process of the present invention, which may, in part, be due to the thorough homogenization of the wet materials with the dry constituents.

Beyond the hereinabove described uses of the liquid multi-functional coating material, it is envisioned that the coating material of the present invention could be used for paints and stains for porous, non-polymeric materials.

While the invention has been illustrated and described in its preferred embodiments, it is not intended to be limited to the details shown, since various modifications and structural changes may be made without departing from the spirit and scope of the present invention.

What I claim is:

1. A ready-to-process coated particle comprising a polymeric granule encapsulated by a coating material being comprised of a multi-pigment/additive mixture, wherein the moisture content of the polymeric granule prior to encapsulation by the coating material was no more than 0.25 weight percent, and the moisture content of the ready-to-process coated particle is no more than 0.25 weight percent greater than the moisture content of the polymeric granule prior to encapsulation by the coating material.

2. The ready-to-process coated particle defined in claim 1, wherein the multi-pigment additive mixture comprises up to 90% by weight of one or more inorganic pigments.

3. The ready-to-process coated particle defined in claim 1, wherein the multi-pigment additive mixture comprises up to 45% by weight of one or more organic pigments.

4. The ready-to-process coated particle defined in claim 1, wherein the multi-pigment additive mixture comprises up to 10% by weight of one or more additive materials.

5. A method of making a ready-to-process coated particle comprising:
providing a polymeric granule;
drying the polymeric granule at a temperature below the plastic transition temperature of the polymeric material of which the polymeric granule is formed, for a time sufficient to produce an initial moisture content less than 0.25 weight percent in the polymeric granule, and in a time sufficient to prevent the dried polymeric granule from absorbing moisture in a coating vessel, applying a liquid coating material over the entirety of the surface of the polymeric granule to form a uniform coating thereon; and
removing the free liquid from the coating vessel while simultaneously heating the coating vessel to a temperature below the melting temperature of the coating material and the polymeric granule;
wherein the moisture content of the coated granule is no more than 0.25 weight percent greater than the initial moisture content of the uncoated polymeric granule.

6. The method of making the coated particle defined in claim 5, wherein the viscosity of the liquid coating material is at least 28 seconds in a #4 Ford cup.

7. A liquid, multi-functional coating material comprising:
at least one inorganic pigment;
at least one organic pigment;
at least one organic coupling agent; and
at least one liquid organic solvent,
wherein the at least one inorganic pigment, the at least one organic pigment, the at least one coupling agent, and the liquid organic solvent are mixed to form a dispersion having a viscosity of at least 28 seconds in a #4 Ford cup; the at least one inorganic pigment, the at least one inorganic pigment and the at least one organic coupling agent comprise about 20% to about 30% by weight of the total weight of the dispersion; and the at least one liquid organic solvent comprises about 70% to about 80% by weight of the total weight of the mixture.

8. The liquid, multi-functional coating material defined in claim 7, wherein the at least one organic coupling agent comprises one or more titanate compounds.

9. The liquid, multi-functional coating material defined in claim 7, wherein the at least one liquid organic solvent comprises one chosen from the group consisting of: water, hydrocarbons, long-chain amines, vegetable oils, monohydric aliphatic alcohols, ketones, glycol ethers, diols, polyether diols, aliphatic triols and tetrols having 2-6 carbon atoms, and mixtures thereof.

10. The liquid, multi-functional coating material defined in claim 7, wherein a polymeric granule is encapsulated by the liquid coating material.

11. The liquid, multi-functional coating material defined in claim 10, wherein the encapsulated polymeric granule is a natural engineering resin.

12. The liquid multi-functional coating material defined in claim 7, wherein the coating material is applied to the surface of items made from sheets or panels of polymeric materials.
